(19) United States
(12) Patent Application Publication
(10) Pub. No.: US 2013/0252603 A1
(43) Pub. Date: Sep. 26, 2013

(54) Signalling Method and Apparatus

(71) Applicant: RENESAS MOBILE CORPORATION, Tokyo (JP)

(72) Inventors: Antti Oskari IMMONEN, Helsinki (FI); Jouni Kristian KAUKOVUORI, Vantaa (FI); Christopher Peter CALLENDER, Kinross (GB)

(73) Assignee: RENESAS MOBILE CORPORATION, Tokyo (JP)

(21) Appl. No.: 13/848,413

(22) Filed: Mar. 21, 2013

(30) Foreign Application Priority Data
Mar. 23, 2012 (GB) 1205163.7

(51) Int. Cl. H04W 8/24

(52) U.S. Cl. CPC H04W 8/24
USPC 455/422.1; 455/550.1

(57) ABSTRACT

There is described a signalling system for a wireless communication network, in which wireless network there are one or more performance categories of different Radio Frequency (RF) front end sections, wherein each category has a performance capability associated therewith. The system includes: retrieving from memory at the user device information indicative of the category, or its associated performance capability, appropriate for the RF front end section of the user device; and transmitting a signalling message to a network entity, the signalling message including the information. The network entity may manage the user device based on the information.

### CROSS REFERENCE TO RELATED APPLICATION

This application claims the benefit under 35 U.S.C. §119(a) and 37 CFR §1.55 to UK Patent Application No. 1205163.7 filed on Mar. 23, 2012, the entire content of which is incorporated herein by reference.

### TECHNICAL FIELD

The present invention relates to a signalling method and apparatus to indicate a user equipment front end capability.

### BACKGROUND

In cellular communications networks, a user equipment (UE), communicates with the network via a base station that serves the cell within which the UE is currently located. A UE typically includes a Radio Frequency (RF) front-end module and a Radio Frequency Integrated Circuit (RFIC), located between its antenna and base band processor. The RF front-end module includes components, for example, filters, switches, amplifiers, duplexers, splitters and the like that process (e.g. filter) signals received from a base station at an incoming Radio Frequency and process (e.g. filter) outgoing radio frequency signals for transmission to the base station. The RFIC includes in the receiver chain a mixer for down converting the received Radio Frequency signals to a lower frequency for processing by the base band processor and in the transmitter chain a mixer for up-converting signals generated by the base band processor to an outgoing Radio Frequency for transmission to the base station.

Modern cellular communication networks, for example those that conform with LTE release 10, provide for so called Carrier Aggregation (CA) to increase bandwidth and hence per link data rates. A UE capable of carrier aggregation may receive (as specified in LTE Release 10) or transmit (not specified in LTE release 10 but it will be in later releases) simultaneously on multiple RF component carriers. Three different cases of CA can be identified:
(a) Intra-band aggregation with frequency-contiguous component carriers (i.e. the component carriers are within the same allocated frequency band and are consecutive);
(b) Intra-band aggregation with non-contiguous component carriers (i.e. the component carriers are within the same allocated frequency band but are not consecutive); and
(c) Inter-band aggregation (i.e. component carriers are in different allocated frequency bands).

It is anticipated that different classes of UEs, each having a different type of RF front end architecture, will be provided that support Inter-band aggregation.

A first type of UE includes a RF front-end architecture based on a ‘traditional’ single-feed antenna interface where there is one cellular antenna that covers all of the different frequency bands used for inter band aggregation and including additional, relative to a release 8 only compatible UE, passive components for splitting the signals from the different bands at the antenna. These components may include a diplexer, a quadplexer, switches etc. It is the case that these additional passive RF front-end components will introduce greater signal losses at the UE, relative to a release 8 only compatible UE, which losses have certain performance impacts. For example, if this loss is compensated for at the UE transmitter side, the UE current consumption will increase, if maximum power output for the UE is not relaxed, and consequently battery life will decrease. As the losses are caused by passive components, wasted power is transformed into heat, which can be problematical, particularly for small form factor UEs. At the UE receiver side, the additional loss results in a lower signal to noise ratio (e.g. a poorer reference sensitivity level). If the loss is absorbed at the network receiver side, then the UE's coverage, and thus the cell radius, decreases and there is a decrease in data rate.

The standards document 3GPP TS 36.101 v10.5.0 (2011-12) defines in section 6.2.5 that a UE is permitted to configure its maximum output power P_{CMAX} according to the following relationship:

P_{CMAX}_{_{—}}_{L}≦P_{CMAX}≦P_{CMAX}_{_{—}}_{H}

where P_{CMAX}_{_{—}}_{L} represents a maximum output power lower tolerance and P_{CMAX}_{_{—}}_{H} represents a maximum output power upper tolerance. The document further defines in section 6.2.5A, for inter-band non-contiguous carrier aggregation, the parameter ΔT_{IB,c}, as being the additional tolerance for serving cell c, when determining P_{CMAX}_{_{—}}_{L}.

The standards document 3GPP TS 36.101 v10.5.0 (2011-12) defines in section 7.3 that the reference sensitivity power level REFSENS is the minimum mean power applied to UE antenna ports at which the throughput shall meet or exceed the requirements for the specified reference measurement channel. In section 7.3.1 the document specifies that for QPSK, the minimum throughput requirements shall be ≧95% of the maximum throughput of the reference measurement channels as specified in Annexes A.2.2, A.2.3 and A.3.2 with parameters specified in Table 7.3.1-1 and table 7.3.1-2. The document further specifies in section 7.3.1 for a UE which supports inter-band CA configuration, the parameter ΔR_{IB} which represents a minimum amount by which the reference sensitivity shall be increased for the E-UTRA bands applicable to the CA.

Currently the document specifies values for ΔR_{IB} of 0 dB (see Table 7.3.1A-2) and for ΔT_{IB,c} of 0.3 dB that are applicable for the Inter Band CA configuration CA_{—}1A-5A only, i.e. a configuration involving Band 1 (uplink range 1920 MHz-1980 MHz; downlink range 2110 MHz-2170 MHz) and Band 5 (uplink range 824 MHz-849 MHz; downlink range 869 MHz-894 MHz).

All of the current values for P_{CMAX}_{_{—}}_{L}, ΔT_{IB,c}, ΔR_{IB} are selected on the assumption that a UE includes a RF front end architecture based on the ‘traditional’ single-feed antenna interface. These specific values for ΔR_{IB} and ΔT_{IB,c} have been agreed by UE vendors and network operators and represent a trade-off compromise between additional losses at the UE side and that of cell coverage as well. For LTE release 11 it has been agreed that these values will apply for all CA low-high band combinations, not just the Band 1 and Band 5 combination, but currently, corresponding values for other types of CA band combination are for further study. It is anticipated that values of ΔR_{IB}ΔT_{IB,c} for UEs that support multiple and especially overlapping band combinations may be relatively large.

A second type of UE includes a RF front end architecture based on a multi-feed antenna interface where there are multi cellular antennas, each antenna being for a respective one of the different frequency bands used for inter band aggregation. Unlike the traditional single feed antenna interface, this type of architecture does not require additional passive components, or if it does, the required components will introduce losses that are minimal compared to those introduced by the additional components of the traditional single feed antenna interface. This type of RF front end architecture therefore has different performance capabilities than those of the traditional single feed architecture. Other different types of RF front end architecture also exist (or will exist) each having their own associated passive component losses.

It is desirable to provide a new way of enabling better network management of User Equipments that have different RF front end architectures or RF front end capabilities.

### SUMMARY

According to an aspect of the present invention, there is provided a signalling method for a user device in a wireless communication network, the method including: causing transmission of a signalling message to an entity in the wireless communication network, the signalling message indicating an insertion loss performance capability of a radio frequency front end of the user device.

According to an aspect of the present invention, there is provided a network apparatus for a wireless communication network, the apparatus including: at least one processor; and at least one memory including computer program code; the at least one memory and the computer program code configured to, with the at least one processor, cause the apparatus at least to perform: receiving from a user device a signalling message indicating an insertion loss performance capability of a radio frequency front end of the user device.

According to an aspect of the present invention, there is provided an apparatus for a user device in a wireless communication network, the apparatus including: at least one processor; and at least one memory including computer program code; the at least one memory and the computer program code configured to, with the at least one processor, cause the apparatus at least to perform: causing transmission of a signalling message to an entity in the wireless communication network, the signalling message indicating an insertion loss performance capability of a radio frequency front end of the user device.

According to an aspect of the present invention, there is also provided a non-transitory computer-readable storage medium including a set of computer-readable instructions stored thereon, which, when executed by a processing system of a user device in a wireless communication network, cause the processing system to cause transmission of a signalling message to an entity in the wireless communication network, the signalling message indicating an insertion loss performance capability of a radio frequency front end of a user device.

According to an aspect of the present invention, there is also provided a non-transitory computer-readable storage medium including a set of computer-readable instructions stored thereon, which, when executed by a processing system of a network apparatus for a wireless communication network cause the processing system to receive from a user device a signalling message indicating an insertion loss performance capability of a radio frequency front end of the user device.

Further features and advantages of the invention will become apparent from the following description of some embodiments of the invention, given by way of example only, which is made with reference to the accompanying drawings.

### BRIEF DESCRIPTION OF THE DRAWINGS

FIG. 1 is a schematic illustration of an example communications network;

FIG. 2 is a schematic illustration of an example wireless user equipment;

FIG. 3 is a schematic illustration of an example network entity;

FIG. 4 illustrates example steps that may be performed in a user device in the communications network;

FIG. 5 illustrates example signalling between a user device and a network entity.

FIG. 6 illustrates example steps that may be performed in a network entity in the communications network;

### DETAILED DESCRIPTION

Exemplary embodiments are concerned with methods and apparatus for signalling for a user device in a wireless communications network. Certain embodiments are particularly suitable for use in mobile wireless networks such as a Universal Terrestrial Radio Network (UTRAN), a Long Term Evolution (LTE) network, a Long Term Evolution Advanced (LTE-A) network, a Wideband Code Division Multiply Access (WCDMA) network, and in Wireless Local Area Networks (WLAN), a Global System for Mobile Communications (GSM) network, or a GSM Edge network (GERAN).

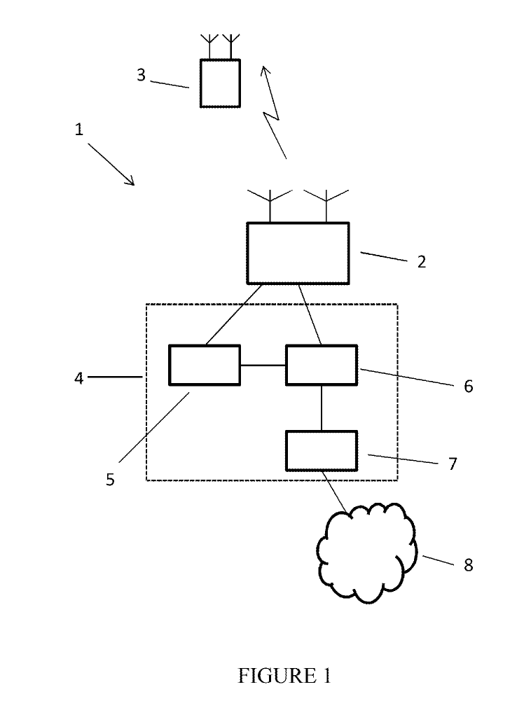

FIG. 1 schematically illustrates a communication network 1 including a base station or access point 2 for communicating over a radio air interface with one or more mobile user devices 3 present in a geographical area served by the base station 2. It will be understood that the wireless communication network 1 may include a plurality of such base stations 2, each serving a different one of a plurality of contiguous geographical areas, although for simplicity only a single base station 2 is shown. The communications network 1 further includes a core network 4 for exchanging control signalling and user data with the base station 2. In one example, if the network 1 is based on a LTE network, the core network may include a mobile management entity 5 and a serving gateway 6 for exchanging control plane signalling and user plane data respectively with the base station 2, with the serving gateway 6 connected to a packet data gateway 7 for connectivity to external networks 8, such as the Internet.

In the communication network 1 transmissions from the base station 2 to a user device 3 are on the downlink (DL) (sometimes referred to as the forward link) and transmissions from a user device 3 to the base station 2 are on the uplink (UL) (sometimes referred to as the reverse link). In the example of an LTE system, the downlink transmission scheme is based on Orthogonal Frequency Division Multiplexing (OFDM) and the uplink transmission scheme is based on Single Carrier Frequency Division Multiplexing (SC-FDMA).

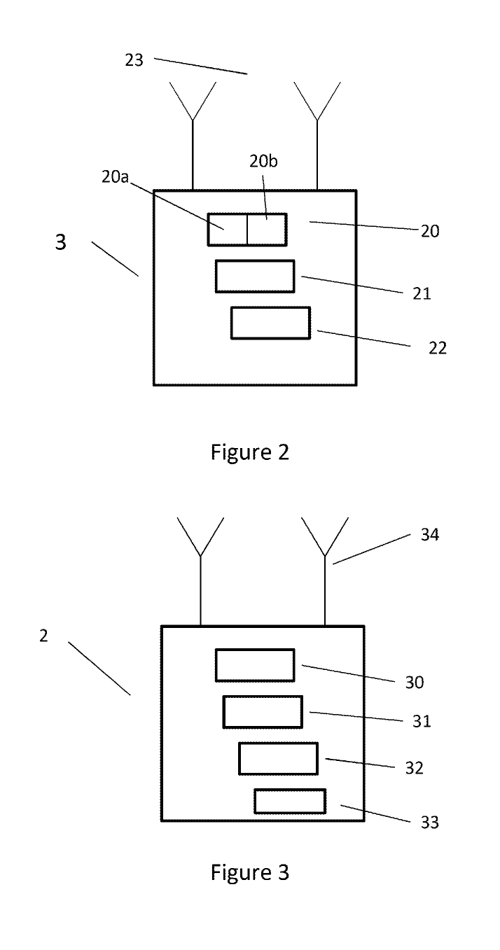

FIG. 2 shows schematically the user equipment or wireless device 3, in this case in the form of a mobile phone/smartphone. The user equipment 3 contains the necessary Radio Frequency components 20, including a RF front-end section 20a and RFIC 20b, together with base band processor(s) 21 and memory/memories 22, multiple antennas 23, etc. that enable wireless communication with the network as described above.

The RF front-end section 20a may, in a receive chain, process (e.g. filter) RF wireless signals received from the base station 2, and, in a transmit chain, process (e.g. filter) RF signals for transmission to the base station 2. The RFIC 20b in the receive chain may convert the RF signals received from the base station 2 to lower frequency signals for processing by the base band processor(s) 21, and, in the transmit chain, convert lower frequency signals from the baseband processor(s) 21 to RF frequency signals for transmission to the base station 2.

The baseband processor(s) 21 perform baseband signal processing including analog to digital conversion (ADC)/digital to analog conversion (DAC), gain adjusting, modulation/demodulation encoding/decoding etc. Alternatively, the ADCs and DACs may be in the RFIC.

FIG. 3 shows schematically a network entity 2 suitable for use as the base station in FIG. 1. The term “base station” is used in this specification to include a “traditional” base station, a Node B, an evolved Node B (eNB), or any other access point to a network, unless the context requires otherwise. The network entity 2 includes its own RF components 30, baseband processor(s) 31 memory/memories 32, schedulers 33, and multiple antennas 34 etc to enable wireless communication with the user device 3 as described herein.

In some embodiments of the invention in an exemplary network (e.g. a network based on one of those identified above) there are one or more performance categories of user device RF front end sections, each category having a performance capability associated therewith. There may be a plurality of categories.

In one embodiment a first category is associated with a performance capability that complies with a first set of one or more defined performance characteristic values. A second category is associated with a performance capability that complies with a second set of defined one or more performance characteristic values, wherein at least one of the performance characteristic values of the second set is more relaxed than a corresponding one of the performance characteristic values of the first set.

In an embodiment, a first category is associated with a single feed RF front end architecture and a second category is associated with a multi feed RF front end architecture. In this embodiment, the first and second categories are indicative of one or more user equipment operating parameters relevant for carrier aggregation (CA). On the assumption that the multi feed RF front end architecture is less lossy than the single feed RF front end architecture, at least one of the parameter values indicated by the second category may be less restricted than a corresponding at least one of the parameter values indicated by the first category.

The one or performance characteristic values or the one or more parameter values may include a value for P_{CMAX}_{_{—}}_{L}, representing a maximum output power lower tolerance value for a user device and/or a value for reference sensitivity power level REFSENS. Values for the parameters ΔT_{IB,c} and ΔR_{IB} may indicate by how much the values for P_{CMAX}_{_{—}}_{L} and REFSENS are relaxed relative to base line values.

The performance capability may relate to an insertion loss associated with the RF front end architecture associated with a category. An insertion loss may be associated with the downlink and/or the uplink. An insertion loss for the downlink may be different than (e.g. larger) than one for the uplink.

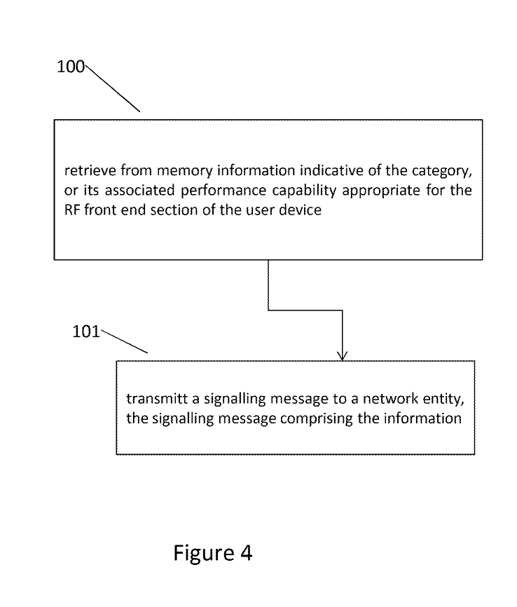

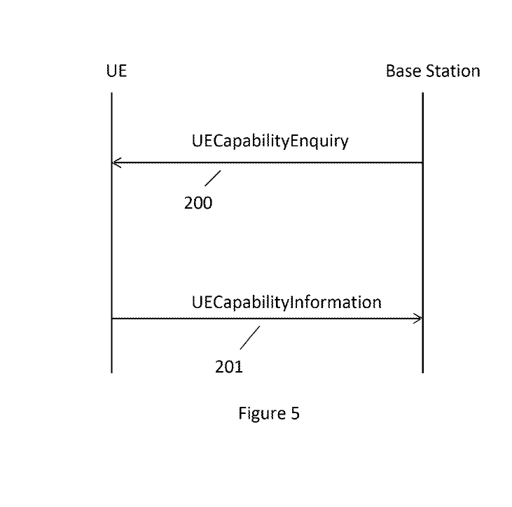

Accordingly, as is illustrated in FIG. 4, in some exemplary embodiments of the invention, in step 100, the user device 3, or some component thereof, retrieves from memory information indicative of the category, or its associated performance capability appropriate for the RF front end section of the user device 3 and, in step 101, causes transmission of a signalling message to a network entity, for example, base station 2, the signalling message including the information.

Advantageously, having received the signalling message, the base station 2 may apply network management to the user device 3 which is appropriate for the performance capability of that RF front end architecture indicated by the signalling.

Referring now to FIG. 5, in one example of a modified LTE communication system, at some point in time after the user device 3 has connected to the base station 2, the user device 3 receives a message, for example a UECapabilityEnquiry message 200 (which may for example be of the format shown on page 142 in 3GPP TS 36.331 version 10.4.0 Release 10), transmitted to the user device 3 from the base station 2. In response to receiving the message 200, the user device 3 generates and then transmits to the base station 2 a reply message, for example, a UECapabilityInformation message 201. More particularly, the user device 3 retrieves from memory the information indicative of a category, or performance capability, appropriate for the RF front end architecture of the user device 3 and includes this information in the UECapabilityInformation message 201 (which may for example be of the format shown straddling pages 142 and 143 in 3GPP TS 36.331 version 10.4.0 Release 10).

Specifically, in one example, the information may be included in the UECapabilityInformation message 201 as a UE-EUTRA-Capability information element (which may for example be of the general format shown on pages 223 to 239 of 3GPP TS 36.331 version 10.4.0 Release 10). Alternatively, the information may be included as a ‘nonCriticalExtension’ which would be defined in 3GPP TS 36.331.

In one example, there are defined N (N being an integer >than 1) RF front end (FE) classes, one for each of N different RF front end architectures or performance capabilities available in the network. As an illustrative example, if two different RF front end architectures are available, namely, a single feed RF front end architecture and a multi feed RF front end architecture, then N=2 and there are defined 2 RF front end (FE) classes, say, RFFEclass=1 (for single feed RF front end architecture) and RFFEclass=2 (for the multi-feed RF front end architecture). The user device 3 has stored in memory the RFFEclass appropriate for itself and includes the RFFEclass as the UE-EUTRA-Capability information element in the UECapabilityInformation message 201.

The relevant RFFE class could be added, for example, in the section ‘RF-parameters’ (see the UE-EUTRA-Capability information element ‘RF-parameters’ towards the bottom of page 234 of 3GPP TS 36.331 version 10.4.0 Release 10) modified as follows:

```
RF-Parameters ::= SEQUENCE {
    supportedBandListEUTRA SupportedBandListEUTRA
    supportedRFFEclass  INTEGER  (1,.....N) ]
}
```

where the additional new signalling is indicated in bold.

The UECapabilityInformation message 201 may be sent using signalling radio bearer SRB1 and the Logical channel Dedicated Control Channel (DCCH).

The base station 3 (or a component thereof) maintains (or is informed of by the core network) a record indicating for each RFFE class, a set of one or more operating parameters values associated with that RFFE class. Continuing with the example given above of a defined RFFEclass=1 (for single feed RF front end architecture) and a defined RFFEclass=2 (for the multi-feed RF front end architecture), the record may, for example, indicate for each RFFEclass operating parameters that are relevant for carrier aggregation (CA), in particular, which UE maximum output power lower tolerance P_{CMAX}_{_{—}}_{L} and REFSENS per each band/band combination apply to each RFFEclass.

As an illustrative example applicable to Inter-band CA on the downlink only using Frequency Bands (FB) 1 and 5 defined by 3GPP for LTE and assuming: (i) a nominal P_{CMAX}_{_{—}}_{L}=21 dBm; (ii) that the B1+B5 combination has a defined ΔT_{IB,c} of 0.3 dB relaxation to P_{CMAX}_{_{—}}_{L} and a ΔR_{IB} relaxation of 0 dB to REFSENS for RFFEclass=1; and (iii) that the B1+B5 combination has a defined ΔT_{IB,c} of 0 dB relaxation to P_{CMAX}_{_{—}}_{L} and a ΔR_{IB} relaxation of 0 dB to REFSENS for RFFEclass=2,

the record for RFFEclass=1 could read:

Signal B1+B5,B1,B5P_{CMAX}_{_{—}}_{L}=20.7dBm

and that for RFFEclass=2 could read:

Signal B1+B5,B1,B5P_{CMAX}_{_{—}}_{L}=21dBm

It will be appreciated that other RF front end (FE) classes may be defined, either in addition to or instead of the two classes described above, each associated with a different user device RF front end capability or architecture. For example, one further type of known RF front end architecture may be utilized by half duplex UE which do not have the capability to receive and transmit simultaneously on FDD bands. This half duplex operation negates the need for a duplex filter (although a low pass filter in the transmit chain (or a high pass filter in the case of a reverse Frequency Division Duplex band arrangement (i.e. uplink band is a higher than downlink band) and a band pass filter in the receive chain would remain) in the RF front end and consequently the insertion losses of the RF front end are reduced relative to a full duplex configuration. Accordingly, a third RF front end (FE) class may be defined, say, RFFEclass=3 (for half duplex without duplex filter RF front end architecture). As a further example, it is anticipated that, in the future, there will be RFFE-filterless design architectures. Accordingly, a fourth RF front end (FE) class may be defined, say, RFFEclass=4 (for filterless RF front end architecture). As a yet further example, a further type of known RF front end architecture is utilized by UEs that have just a single receiver. Such single receiver UEs do not allow for receiver diversity gain, which may result in reduced coverage from a baseband processing perspective, but typically also have a simplified RFFE architecture with reduced losses. Accordingly, a fifth RF front end (FE) class defined, say, RFFEclass=5 (for single receiver reduced complexity RF front end architecture), although, alternatively, a filterless single receiver architecture could be classed as part of the RFFEclass=4, or as part of a broader ‘light filtering’ class. In each case, the base station 3 maintains (or is informed by the core network) a record indicating for each RFFE class, a set of one or more operating parameters values associated with that RFFE class.

It will be appreciated that even if a user device has a RFFE that is nominally a ‘high loss’ and hence ‘low performance’ class, say RFFEclass=1, in some operational circumstances, its performance may be at the level associated with a ‘low loss’ and hence ‘high performance’ class, say FFFEclass=2. In one embodiment, if a user device's current performance justifies signalling a class different to the class of its implementation architecture then the user device may do so.

It will further be appreciated that there are alternative ways for a user device 3 to signal the information indicative of the category to a base station 2 other than using the RFFEclass signalling described above. For example, a user device 2 may store a set of one or more operating parameters values associated with its RF front end architecture and which implicitly identify the category, and transmit the set to the base station in a UECapabilityInformation message in response to a UECapabilityEnquiry message. That is to say for example, using the inter-band CA illustration, given above, that if the user device has the multi-feed RF front end architecture it explicitly signals to the base station the information:

B1+B5,B1,B5P_{CMAX}_{_{—}}_{L}=21dBm

which indicates to the base station that the category is RFFEclass=2.

Alternatively, (and especially for the single receiver reduced complexity RF front end architecture or the half duplex without duplex filter RF front end architecture) a new UE category, over and above the current UE categories 1-8 which are defined by 3GPP releases 8-10, may be defined for each front end architecture type. For example, a UE having a single receiver reduced complexity RF front end architecture may have a lower data rate category which corresponds a new UE category 9 (or anyway a category number not currently defined). As well as implying reduced data rates, the new UE category may imply performance based on single receiver and simplified (e.g. less lossy) front end architecture with a corresponding difference in downlink coverage.

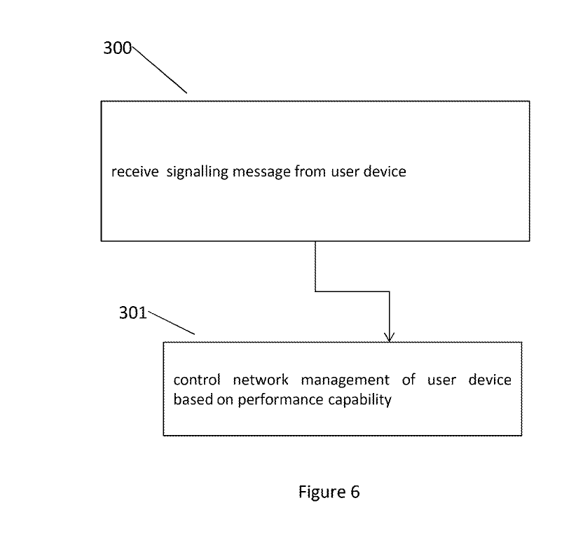

Referring now to FIG. 6, in step 300, a network entity for example, the base station 2 receives the signalling message from the use device 3, the signalling message including information indicative of the category, or its associated performance capability, appropriate for the RF front end architecture of the user device 3. In step 301, the network entity, or a component thereof controls network management of the user device 3 based on the performance capability associated with the category indicated by the information.

As the base station 2 is now aware of whether the user device 3 is likely to have a reduced (e.g. for higher loss front end architectures), or improved (e.g. for lower loss front end architectures), coverage on both uplink and downlink, it can therefore manage the user device 3 appropriately when it is in a RRC connected state. Specifically, the base station may adapt parameters including mobility thresholds, HARQ parameters, reported CQI, reported RI, uplink resource allocation and so on. As a general principle, a user device that indicates a front end architecture that has high losses, e.g. that reports e.g. single feed RF front end architecture, is scheduled less aggressively, or, if necessary (and possible) handed over to another available RAT technology such as WCDMA or interfrequency LTE to avoid running out of coverage.

Various base station handling procedures are envisaged, which indicate how the information may be beneficially used. A non-exhaustive list of LTE relevant examples is as follows:
Different thresholds may be used for interfrequency or inter-RAT radio resource management procedures on the UE. For example, UE which are known to have reduced coverage may be configured to report event A2 (serving cell becomes lower than an absolute threshold) with a higher threshold value, and those which have better coverage can be configured with a lower A2 threshold. A2 event is typically used to trigger interfrequency or interRAT measurement gaps.
Similarly, the threshold1 for event A5 to trigger interfrequency handover (Event A5 (PCell becomes worse than threshold1 and neighbour becomes better than threshold2) or event B2 to trigger inter RAT handover (Event B2 (PCell becomes worse than threshold1 and inter RAT neighbour becomes better than threshold2) can be adapted by the eNB using knowledge of the device FE architecture/coverage.
Different Hybrid Automatic Repeat Requests (HARQ) parameterization can be used with user devices which are known to have better (or worse) coverage in both uplink or downlink directions. For example, maximum allowed number of retransmissions could be adapted to the user device performance.
Corrections could be applied to the channel quality indicator (CQI) reported by the user device. The need for this depends on the definition and implementation of CQI in the user device; to an extent devices can be expected to automatically adapt their CQI anyway (lower reference symbol SNR would automatically trigger lower CQI reporting). If the eNB is aware of UE front end architecture it may for example schedule the UE with a different transport block size
Corrections to the rank indicator (RI) reported by the user device may be applied similarly to corrections to CQI.
The eNB may adapt the resources that it gives to as UE, especially in the uplink direction where it can use prior knowledge that a device is more likely to be power limited because of its FE architecture to give it a lower uplink scheduling and vice versa.

Although at least some aspects of the embodiments described herein with reference to the drawings include computer processes performed in processing systems or processors, the invention also extends to computer programs (which may implement algorithms), particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may include a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), etc. The chip or chips may include circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the example embodiments may be implemented at least in part by computer software stored in (non-transitory) memory and executable by the processor, or by hardware, or by a combination of tangibly stored software and hardware (and tangibly stored firmware).

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A signalling method for a user device in a wireless communication network, the method comprising:
causing transmission of a signalling message to an entity in the wireless communication network, the signalling message indicating an insertion loss performance capability of a radio frequency front end of the user device.

2. The method of claim 1, wherein, in the wireless network, there are one or more performance categories of Radio Frequency (RF) front end sections, wherein each category has a different insertion loss performance capability associated therewith, the method further comprising:
retrieving from memory at the user device information identifying the category, or its associated insertion loss performance capability, appropriate for the RF front end section of the user device; and
providing the information in the signalling message.

3. The method of claim 2, wherein a first category is associated with an insertion loss performance capability that complies with a first set of one or more performance characteristic values.

4. The method of claim 3, wherein a second category is associated with an insertion loss performance capability that complies with a second set of one or more performance characteristic values, wherein at least one of the performance characteristic values of the second set is more relaxed than a corresponding one of the performance characteristic values of the first set.

5. The method of claim 3 wherein the one or more performance characteristic values include a value for maximum output power lower tolerance (P_{CMAX}_{_{—}}_{L}) and/or a reference sensitivity power level (REFSENS).

6. The method of claim 2 wherein a first category is associated with a first RF front end architecture and a second category is associated with a second RF front end architecture that is less lossy than the first RF front end architecture, and wherein the first category is associated with at least one operating parameter value for inter-band Carrier Aggregation (CA) using the first RF front end architecture and the second category is associated with at least one corresponding operating parameter value for inter-band CA using the second RF front end architecture.

7. The method of claim 6 wherein the first RF front end architecture is single feed RF front end architecture and the second RF front end architecture is a multi-feed RF front end architecture.

8. The method of claim 2 wherein the information explicitly identifies the category or its insertion loss performance capability.

9. The method of claim 2 wherein the information comprises one or more operating parameter values that implicitly identifies the category or its insertion loss performance capability.

10. The method of claim 1 wherein the signalling message is transmitted in response to a request received from a network entity.

11. The method of claim 1, the method comprising:
performing a procedure at the user device in accordance with network controlled management of the user device, the network controlled management having been configured by the network at least partly based on the insertion loss performance capability indicated by the signalling message.

12. A network apparatus for a wireless communication network, the apparatus comprising:
at least one processor; and
at least one memory including computer program code;
the at least one memory and the computer program code configured to, with the at least one processor, cause the apparatus at least to perform:
receiving from a user device a signalling message indicating an insertion loss performance capability of a radio frequency front end of the user device.

13. The apparatus of claim 12, wherein, there are one or more performance categories of Radio Frequency (RF) front end sections, wherein each category has an insertion loss performance capability associated therewith, the apparatus being configured to:
receive the signalling message from the user device, the signalling message comprising information identifying the category, or its associated insertion loss performance capability, appropriate for the RF front end section of the user device.

14. The apparatus of claim 12, the apparatus being configured to:
control network management of the user device at least partly based on the insertion loss performance capability indicated by the signalling message.

15. The apparatus of claim 14 wherein the network management of the user device comprises at least one selected from: adapting a handover threshold value for the user device based on the performance capability; adapting a Different Hybrid Automatic Repeat Requests (HARQ) parameterization for the user device based on the performance capability; applying a Channel Quality Indicator (CQI) or Rank Indicator (RI) correction for the user device based on the performance capability; adapting scheduling of the user device based on the performance capability.

16. Apparatus for a user device in a wireless communication network, the apparatus comprising:
at least one processor; and
at least one memory including computer program code;
the at least one memory and the computer program code configured to, with the at least one processor, cause the apparatus at least to perform;
causing transmission of a signalling message to an entity in the wireless communication network, the signalling message indicating an insertion loss performance capability of a radio frequency front end of the user device.

17. The apparatus of claim 16, wherein, in the wireless network, there are one or more performance categories of Radio Frequency (RF) front end sections, wherein each category has a different insertion loss performance capability associated therewith, the apparatus being configured to:
retrieve from memory at the user device information identifying the category, or its associated insertion loss performance capability, appropriate for the RF front end section of the user device; and
provide the information in the signalling message.

18. The apparatus of claim 17, wherein a first category is associated with an insertion loss performance capability that complies with a first set of one or more performance characteristic values.

19. The apparatus of claim 18, wherein the one or more performance characteristic values include a value for maximum output power lower tolerance (P_{CMAX}_{_{—}}_{L}) and/or a reference sensitivity power level (REFSENS).

20. Apparatus of claim 16 wherein the apparatus is configured to be used in a Long Term Evolution (LTE) or Long Term Advanced (LTE-A) wireless network.
